(19) United States
(12) Patent Application Publication
(10) Pub. No.: US 2008/0238910 A1
(43) Pub. Date: Oct. 2, 2008

(54) Overdriving A Pixel Of A Matrix Display

(75) Inventors: Michiel Adriaanszoon Klompenhouwer, Eindhoven (NL); Leo Jan Velthoven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,412

(22) PCT Filed: Mar. 24, 2005
(86) PCT No.: PCT/IB05/51027

§ 371 Date: Sep. 28, 2006

(30) Foreign Application Priority Data
Apr. 1, 2004 (EP) 04101362.4

(51) Int. Cl. G09G 5/00

(52) U.S. Cl. 345/214

(57) ABSTRACT

An overdrive circuit (20) for a display panel (1) comprising a pixel (10) having inertia further comprises a table look up circuit (24) or a function circuit (24) which receives a start value (SV) and a desired value (DV) being either an input value (IV) indicating an image to be displayed, or a clipped value (CV) and which supplies an overdrive value (OV) to the pixel (10). A substituting circuit (30) substitutes the input value (IV) by a reachable response within one predetermined period (Tf) starting from the start value (SV) to obtain the clipped value (CV). A memory (23) receives the clipped value (CV) to supply the start value (SV) which is the clipped value (CV) delayed over the one predetermined period (Tf). The substituting circuit (30) comprises a table look up circuit or a function circuit (22) which indicates for the start value (SV) a corresponding minimum value (MI) reached from the start value (SV) within one predetermined period (Tf) if a minimum drive value (MID) is applied to the pixel (10), and a corresponding maximum value (MS) reached from the start value (SV) within one predetermined period (Tf) if a maximum drive value (MAD) is applied to the pixel (10).

### FIELD OF THE INVENTION

The invention relates to an overdrive circuit for a display panel, to a display device and display apparatus comprising the overdrive circuit, and to a method of overdriving a pixel of a display panel.

### BACKGROUND OF THE INVENTION

Liquid Crystal Displays (further referred to as LCD's) are known to exhibit an imperfect temporal optical response, see N. Fisekovic et al., Improved motion picture Quality of AM-LCD's using scanning backlight, IDW2001, pp. 1637-1640. A step in the input signal of successive video frames does not lead to a respective step in the luminance output. Instead, the LCD shows considerable latency, the luminance output slowly approaches the desired value. A method called overdrive is used to speed up the response of the LCD. For example, if a brightness transition to a higher brightness is desired, a higher data level or data value than the data value required for reaching in the end the desired brightness value is supplied to the LC material. The higher data value may be selected to reach the desired brightness value within one frame period. Two well know embodiments to implement overdrive are usually referred to as feed-forward overdrive and feedback overdrive.

The feed-forward overdrive has a frame buffer to store the input video values to output stored input video values which represent the desired brightness values of the pixels during the previous frame. The feed-forward overdrive circuit uses the input video values of the present frame, the values of the stored input video of the previous frame, and a lookup table to determine the output video values. The lookup table is derived from a measurement of the optical response of a pixel after exactly one frame period for a number of different gray level transitions, and provides start value/desired gray level pairs along the axis and the corresponding required overdrive value in the matrix cells. Such a matrix may comprise an overdrive value for each start value and desired gray level (256*256 matrix for 8 bit data), or has a limited number of overdrive values for a limited number of start values and desired gray levels, for example 64*64. Intermediate values of overdrive values not present in the matrix are interpolated from this 64*64 matrix. If the start value is the left most column of the matrix and the desired gray level is the uppermost row of the matrix, the overdrive value belonging to a particular start value and a particular desired value can be found in the cell belonging to the row indicated by the start level and the column indicated by the desired gray level.

This implementation of overdrive is called feed-forward, because it predicts the overdrive values based on the data values of the current and the previous frames. The actual state of the LC-cells is not taken into account. Due to the practical limitation that the drive level will have a minimum drive value and a maximum drive value, not all optical transitions can be completed within one frame period even if the minimum drive or the maximum drive value is supplied to the pixel. For example for 8 bit values the minimum drive value is 0 and the maximum drive value is 255. Particular drive voltages are associated with these limit drive values, for example 1 volts is supplied to the pixel if the drive value is 0, and 5 volts is supplied to the pixel if the drive value is 255. Thus, the actual optical state of the pixel reached after one frame period may not be equal to the input value. Consequently, some of the gray values stored in the frame buffer do not represent the actual optical state of the pixels at the end of the present frame and thus provide an incorrect start value for the next frame. The feed-forward approach assumed that the desired value was reached. This error may either lead to too much or too little overdrive in the next frame, and thus may give rise to an overshoot or undershoot in the optical state transition of the pixel.

In order to prevent these errors, the values corresponding to the resulting gray levels of the pixels should be stored instead of the values of the previous video frame. This approach is called feedback overdrive, see D. Nakano et. al., Fast Response IPS-LCD Using Feed-Backward Overdrive Technology, IDW 2002, pp. 211-214. This implementation uses two lookup tables which have together twice the size of the feed-forward lookup table. One of the lookup tables is identical to the lookup table used in the feed-forward approach and provides the overdrive values for the start value/desired value pairs. The overdrive values are the values required to reach the desired value starting from the start value within one frame period. The other lookup table provides the response values at the end of the frame period for the start value/desired value pairs. The response values are the values reached at the end of the frame period starting from the start value when the desired value is applied. By using the overdrive value found in the first table as the desired value in the second table, it is possible to find the actual value indicating the actual optical state of the pixel at the end of the frame. This actual value is used in the next frame as the start value.

Although the feedback overdrive has an improved performance with respect to the feed-forward overdrive, its implementation requires a high amount of storage or complicate functions.

### SUMMARY OF THE INVENTION

It is an object of the invention to provide a simpler feedback overdrive.

A first aspect of the invention provides an overdrive circuit for a display panel as claimed in claim 1. A second aspect of the invention provides a display device as claimed in claim 10. A third aspect of the invention provides a display device as claimed in claim 11. A fourth aspect of the invention provides a method of overdriving a pixel of a display panel as claimed in claim 12. Advantageous embodiments are defined in the dependent claims.

The display panel comprises a pixel which has inertia. Usually, the display panel comprises a high number of pixels which each have inertia. With inertia is meant that the optical response of the pixel slowly changes when the drive of the pixels changes. The overdrive circuit comprises a memory, a table lookup unit or a function unit, and a substituting circuit. The memory provides a delay over a predetermined period of time, for example a frame period or a line period.

The table lookup unit or function unit receives a start value and a desired value to supply an overdrive value to the pixel. The desired value indicates the value of the pixel to be reached in the present predetermined period of time. The start value is stored in the memory and indicates the value of the pixel reached in the previous predetermined period of time. The overdrive value is determined using a matrix table wherein the overdrive value is stored for the start value/desired value pairs or by using a predetermined function which outputs the overdrive value as function of the start value and desired value. This as such is known from the prior art feed-forward and feedback overdrive implementations. The desired value is either an input value indicative for the image to be displayed, or a clipped value supplied by the substitute circuit. The memory receives the clipped value and supplies the start value which is the clipped value delayed over one predetermined period.

The substitute circuit receives the input value and comprises a table look up circuit or a function circuit in which for the start value a corresponding minimum value and a corresponding maximum value is stored or determined, respectively. The minimum value is reached, starting from the start value, if a minimum drive value is applied to the pixel. The maximum value is reached, starting from the start value, if a maximum drive value is applied to the pixel. For example, if the data words are 8 bit wide, the minimum drive value is 0, and the maximum drive value is 255. The minimum value and the maximum value reachable within one predetermined period of course depend on the start value.

Thus, the main difference with the prior art feedback overdrive approach is that now is determined for the value of the previous predetermined period, which is read from the memory, what the possible maximum and minimum responses are, reachable in the present predetermined period. If the present input value is within these boundaries it can be stored in the memory to be used in the next frame as the correct start value because the desired input value can be reached with the overdrive circuit. If the present input value is outside these boundaries, the desired input value cannot be reached by the overdrive circuit because the overdrive value cannot be lower than the minimum drive value nor be higher than the maximum drive value; it is only possible to reach either the minimum or maximum value available from the table. Thus to obtain the correct start value for the next predetermined period, this minimum or maximum value available from the table should be stored in the memory. In fact, the value of the input signal is clipped to either minimum value or the maximum value reachable from the start value if the value of the input signal is not in-between these minimum and maximum values.

The table lookup unit or the function unit still requires the prior art matrix table or the prior art function unit which provides the overdrive values for the start value/desired value pairs. However, instead of the matrix table or function circuit which provides the response values for the start value/drive value pairs now only a relatively small table or simple function is required which for each start value supplies the minimum value and the maximum value reachable from this start value with the overdrive circuit. Thus, the amount of memory required for this last matrix table is reduced to the amount of memory required for the last mentioned table. For example, if the matrix table comprises 64 by 64 entries for 64 start values and 64 drive values, the table used in accordance with the invention only comprises 2*64 entries for 64 start values. Thus, the amount of storage required is less than in the prior art feedback overdrive. The function used can be simpler because only a single input variable (the start value) is present. Less functions are required because only the minimum and maximum value have to be generated from the start value.

US2003/0137527 discloses a feed-forward overdrive system. It is disclosed that optical properties of pixels of the LCD's are known to change relatively slow in response to electric field applied. The application of a data voltage to a pixel of the LCD may not rotate the liquid crystal molecules to an angle desired within the desired time period. It is possible to reach the desired change of the optical state of the pixel within the desired time period by temporary enlarging the voltage applied to the pixel. This temporary enlargement of the voltage applied is referred to as overdrive. In fact, indeed, the pixel is overdriven to speed up its optical transition. A VGA chip uses the display data of the present frame, the display data of a previous frame stored in a frame memory, and overdrive data from an overdrive look-up table to determine the output data.

In an embodiment as claimed in claim 2, the predetermined period is a frame period. The optical state of the pixel in the present frame is determined starting from the optical state of the pixel in the previous frame.

In an embodiment as claimed in claim 3, the overdrive value is determined from the start value and the desired value by using a table look up circuit. Alternatively, a predetermined overdrive function(s) may be used.

In an embodiment as claimed in claim 4, the minimum value and the maximum value are determined from the start value by using a table look up circuit.

In an embodiment as claimed in claim 5, the minimum value and the maximum value are determined from the start value by using a predetermined min/max function.

In an embodiment as claimed in claim 6, a relatively small table is used which provides for each possible start value the minimum and maximum values reachable. The number of start values corresponds to the number of possible data levels. For example, for 8 bit data words, the table comprises 256 start values, 256 minimum values and 256 maximum values. Still, considerably less memory is required than to store the 64*64 response values as in the prior art. Further, the accuracy is higher than in the prior art because no interpolation of the values is required.

In an embodiment as claimed in claim 7, only a sub-set of the start values is present, for example for 8 bit words, only 64 start values with corresponding minimum values and maximum values are present in the table. This has the advantage that the required storage for the table further decreases. For the start values which are not in the table, the minimum and maximum values are interpolated from the minimum and maximum values which are present in the table.

In an embodiment as claimed in claim 8, the clipper supplies the clipped value which is: (i) the input value if a level of the input value is higher than the minimum value and lower than the maximum value, or (ii) the minimum value if the input value is equal to or lower than the minimum value, or (iii) the maximum value if the input value is equal to or higher than the maximum value.

In an embodiment as claimed in claim 9, the table look up which is used to determine the overdrive comprises difference values instead of the actual drive values. The difference values indicate the difference between the desired value and the overdrive value and usually are smaller numbers than the overdrive values. This minimizes the storage capacity required for this table.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a matrix display apparatus,

FIG. 2 show select signals and data signals for driving the sub-pixels of the matrix display device,

FIG. 3 show the brightness of a sub-pixel as function of time for several drive signal levels,

FIG. 4 shows a prior art feedback overdrive circuit for a matrix display device,

FIG. 5 show look up tables used in the prior art feedback overdrive circuit,

FIG. 6 shows a block diagram of an embodiment of a feedback overdrive circuit in accordance with the invention,

FIG. 7 shows a block diagram of another embodiment of a feedback overdrive circuit,

FIG. 8 shows an embodiment of the table comprising the minimum and maximum values, and

FIG. 9 shows an example in accordance with the invention indicating the area of the matrix table which is not anymore used.

### DETAILED DESCRIPTION OF THE PREFERRED EMBODIMENT

FIG. 1 shows a block diagram of a matrix display apparatus. The matrix display apparatus comprises signal processing circuitry SPC and a matrix display device comprising a driver D and a matrix display panel 1. The matrix display panel 1 comprises sub-pixels SPij (SP11, SP12, SP21, SP22, SP1n, SP2n, SPm1, SPm2, SPmn) which are associated with intersecting select electrodes SEi and data electrodes DEj. The index i indicates the select electrode SEi involved, the index j indicates the data electrode DEj involved. By way of example only, the matrix display panel 1 shown in FIG. 1 has square sub-pixels SPij and pixels Pk which each comprise four sub-pixels SPij (the pixel P1 indicated comprises the sub-pixels SP11, SP12, SP21, and SP22). The sub-pixels SPij may have other dimensions such as oblong rectangles; the pixels Pk may comprise less or more than three sub-pixels SPij. The matrix, although having generally a rectangular structure, may have any structure. The four sub-pixels SP11, SP12, SP21, SP22 of the pixel P may have the colors red, green, blue and white in any order. The indices i, j, and k are used to indicate the associated items in general, if a particular item is addressed, numbers are conferred to these indices.

The driver D comprises a select driver SD, a data driver DD, a data processor DP, and a timing control circuit TC. The driver may be formed by one or more integrated circuits, or by one or more electronic modules comprising the one or more integrated circuits and optionally additional components. The signal processing circuitry converts an external input signal EIV to the format of the input video signal IV. The apparatus may be a television set, a monitor, a portable computer, a PDA or any other product with a display. The external input signal may be an antenna signal or any other signal from a video source, such as a computer or a DVD-player.

The data processor DP receives the input video signal IV which usually comprises the three input signals R, G, B which represent the colors red, green, and blue, respectively, and which together determine the brightness and color of the input video signal IV. It is assumed that these input signals R, G, B are digital signals of which the number of data pixels corresponds to the number of pixels Pk of the matrix display panel 1. If the video signal IV is an analog signal it has to be digitized first. If the number of data pixels is not equal to the number of pixels Pk a conversion has to be performed. Such a conversion usually is performed by a well known scaler. The data processor DP supplies drive signals Ra, Ga, Ba to the data driver DD.

The timing controller TC receives a horizontal synchronization signal Hs and a vertical synchronization signal Vs of the input video signal IV to supply a control signal CS1 to the data driver DD and a control signal CS2 to the select driver SD. The timing controller TC synchronizes the select driver SD and the data driver DD with the samples of the input video IV and also with respect to each other. The select driver SD supplies select signals Si (S1 to Sm) to the select electrodes SEi, usually to select the select electrodes SEi one by one. The data driver supplies the data signals Dj (D1 to Dn) via the data electrodes DEj to drive the sub-pixels SPij associated with the selected one of the select electrodes SEi.

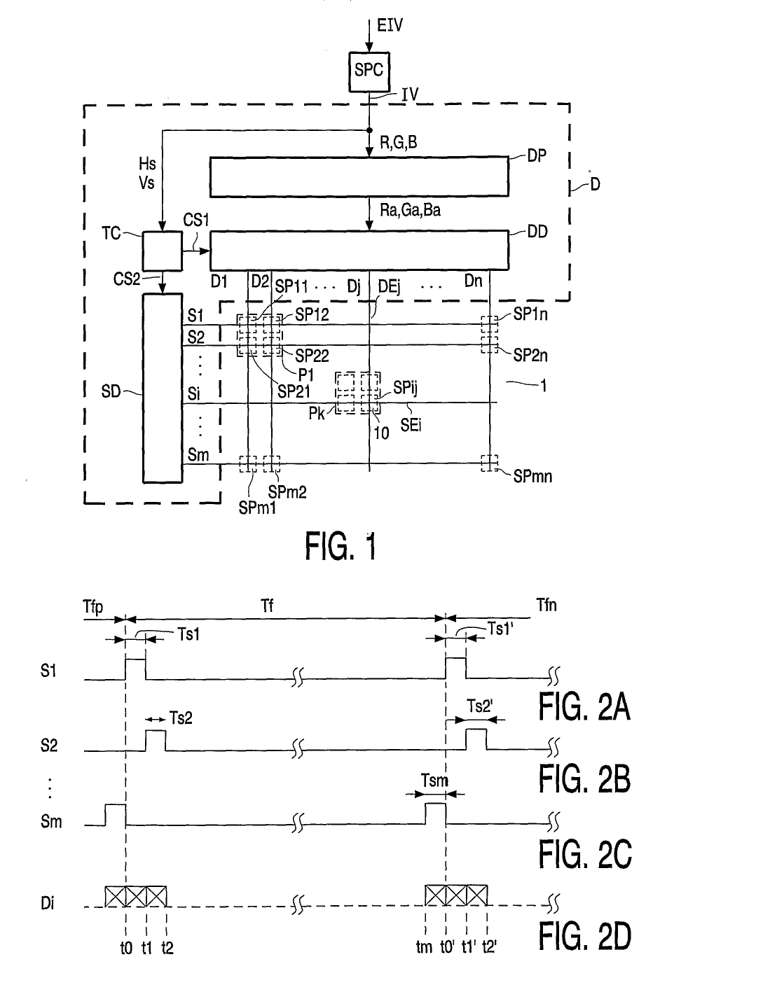

FIG. 2 show select signals and data signals for driving the sub-pixels of the matrix display panel. In all FIG. 2, the horizontal axis represents the time. FIG. 2A shows the select pulses S1 on the first one of the select electrodes SEi. FIG. 2B shows the select pulses S2 on the second one of the select electrodes SEi. FIG. 2C shows the select pulses Sm on the last one of the select electrodes SEi. FIG. 2D shows the data pulses Dj on the data electrodes DEj.

The present frame period Tf starts at the instant t0 and ends at the instant t0′. During the preceding frame period Tfp, the last select electrode is selected by the pulse Sm occurring just before the instant t0. The data Dj supplied to this last select electrode is schematically indicated by a cross. The cross indicates that the different data levels of the different data signals D1 to Dn are supplied in parallel and thus overlap each other in FIG. 2D. During the present frame period Tf, the first select electrode is selected from instant t0 to instant t1 due to the select signal S1 which has a high level during this first select period Ts1. In other displays, the select electrode may be selected with a low or negative level. During this first select period Ts1, the data D1 to Dn supplied in parallel to the data electrodes DEj only influences the sub-pixels SP11 to SP1n associated with the first select electrode. The second select electrode is selected from instant t1 to instant t2 due to the select signal S2 which has a high level during the second select period Ts2. During this second select period Ts2, the data D1 to Dn only influences the sub-pixels SP21 to SP2n associated with the second select electrode. The last select electrode is selected from the instant tm to instant t0′ due to the select signal Sm which has a high level during the last select period Tsm. During this last select period Tsm, the data D1 to Dn only influences the sub-pixels SPm1 to SPmn associated with the last select electrode.

The next frame period Tfn starts at the instant t0′, the first select electrode is selected from instant t0′ to instant t1′ due to the select signal S1 which has a high level during the first select period Ts1′ of the next frame period Tfa. The second select electrode is selected from instant t1′ to instant t2′ due to the select signal S2 which has a high level during this second select period Ts2′ of the next frame period Tfn.

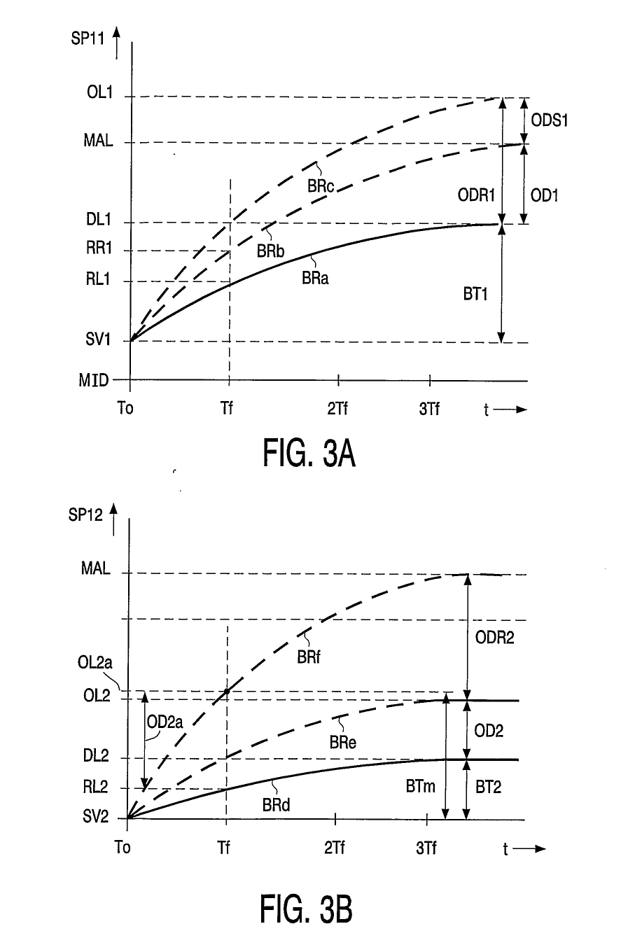

FIG. 3 show the brightness of a sub-pixel as function of time for several drive signal levels. FIG. 3A shows the brightness of a first one of the sub-pixels SPij of the pixel P1, this first one of the sub-pixels SPij is further referred to as the first sub-pixel SP11, FIG. 3B shows the brightness of a second one of the sub-pixels SPij further referred to as the second sub-pixel SP12. Both the sub-pixels SPij are part of the same pixel P1.

In FIG. 3A, the brightness value of the sub-pixel SP11 at the instant To is SV1. The desired brightness level at the end of one frame period Tf, thus at the instant Tf is DL1. If no overdrive is used, the sub-pixel SP11 is driven with a drive signal which corresponds to the data indicating this desired brightness level DL1. Due to the inertness of the LC material, it will take several frame periods Tf until the sub-pixel SP11 has reached the desired brightness DL1, see the line BRa. Now, in the end, near the instant 3Tf, the brightness of the sub-pixel SP11 reaches the desired brightness level DL1, but after one frame period Tf, at the instant Tf, the brightness level reached is only RL1. If within one frame period Tf, thus at the instant Tf the desired brightness level DL1 should be reached, an overdrive data signal corresponding with the brightness level OL1 should be supplied to the sub-pixel SP11. As shown by the dashed line BRc, now the desired brightness DL1 is reached at the instant Tf.

However, usually, the data signal is limited to a maximum drive value MAD corresponding to a maximum voltage available to drive the sub-pixels SPij. When driving the sub-pixel SP11 with this maximum value MAD, a corresponding maximum brightness level MAL is obtained. In FIG. 3A it is assumed that with the maximum drive value MAD, the brightness changes as indicated by the dashed line BRb. Thus, at the end the maximum brightness MAL corresponding to the maximum drive value MAD is reached. Consequently, the clipped brightness RR1 reached at the instant Tf is in-between the brightness level RL1 reached without overdrive and the desired brightness level DL1 reached without clipped overdrive. Thus, due to the clipping of the drive signal as a result of the maximum data signal MAD available, it is not possible to reach the desired brightness level DL1 within one frame period Tf.

The difference between the level DL1 and the level OL1 is referred to as the required overdrive ODR1. The difference between the maximum brightness level MAD and the level OL1 required to reach the desired brightness at the instant Tf is referred to as ODS1. This part ODS1 of the drive cannot be realized because the data signal cannot have a value higher than the maximum drive value MAD. The difference between the maximum brightness MAL and the desired level DL1 is indicated by OD1, and the difference between the starting level SV1 and the desired level DL1 is called the desired brightness transition BT1.

FIG. 3B is very similar to FIG. 3A, now the sub-pixel SP12 has to make a brightness transition BT2 from the starting level SV2 to the desired level DL2. This brightness transition BT2 can be reached within one frame period Tf with overdrive. As is clear from FIG. 3B, the sub-pixel SP12 may make a larger brightness transition. The maximum brightness transition possible is indicated by BTm.

In FIG. 3B, the brightness value of the sub-pixel SP12 at the instant To is SV2.

The desired brightness level at the end of one frame period, thus at the instant Tf is DL2. If no overdrive is used, the sub-pixel SP12 is driven with a drive signal which corresponds to the data indicating this desired brightness level DL2. Due to the inertness of the LC material, it will take several frame periods Tf until the sub-pixel SP12 has reached the desired brightness level DL2, see the line BRd. Thus, in the end, near the instant 3Tf, the brightness of the sub-pixel SP12 reaches the desired brightness level DL2. But after one frame period Tf, at the instant Tf, the brightness level reached is only RL2. If within one frame period Tf, thus at the instant Tf the desired brightness level DL2 should be reached, an overdrive data signal corresponding with the brightness level OL2 should be supplied to the sub-pixel SP12. As shown by the dashed line BRe, now the desired brightness DL2 is reached at the instant Tf.

Again, the data signal is limited to a maximum drive value MAD corresponding to a maximum voltage available to drive the sub-pixels Spij and resulting in a maximum brightness level MAL. In FIG. 3B it is assumed that the maximum data signal MAD would be able to eventually reach the brightness level MAL as indicated by the dashed line BRf. Consequently, at the instant Tf, the sub-pixel SP12 can reach the maximum brightness OL2a which is much higher than the desired brightness level DL2. The difference between the level DL2 and the level OL2 is referred to as the required overdrive OD2. The difference between the maximum possible level MAL and the level OL2 is referred to as ODR2. Although both FIG. 3 show a brightness transition to a brighter state of the sub-pixels SP11 and SP12, a same clipping effect as shown in FIG. 3a may occur for an opposite brightness transition.

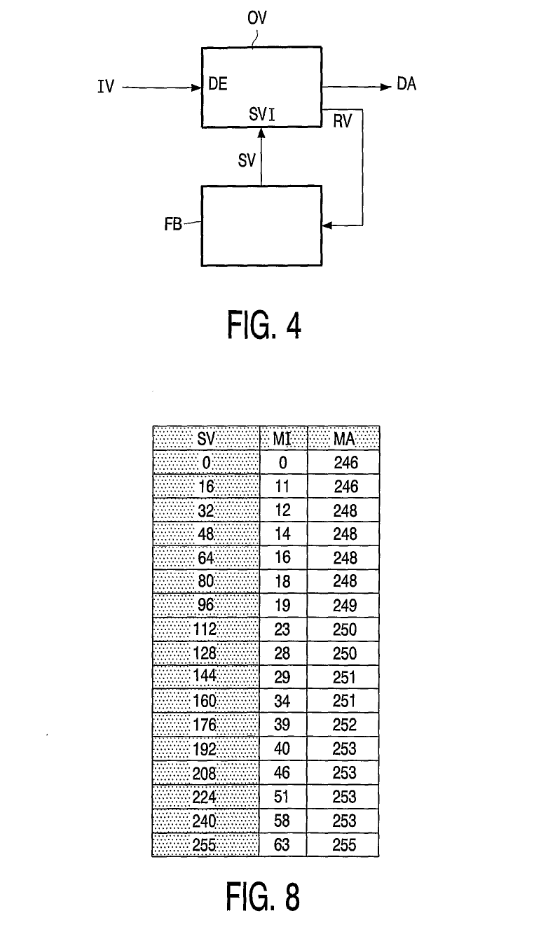

FIG. 4 shows a prior art feedback overdrive circuit for a matrix display device.

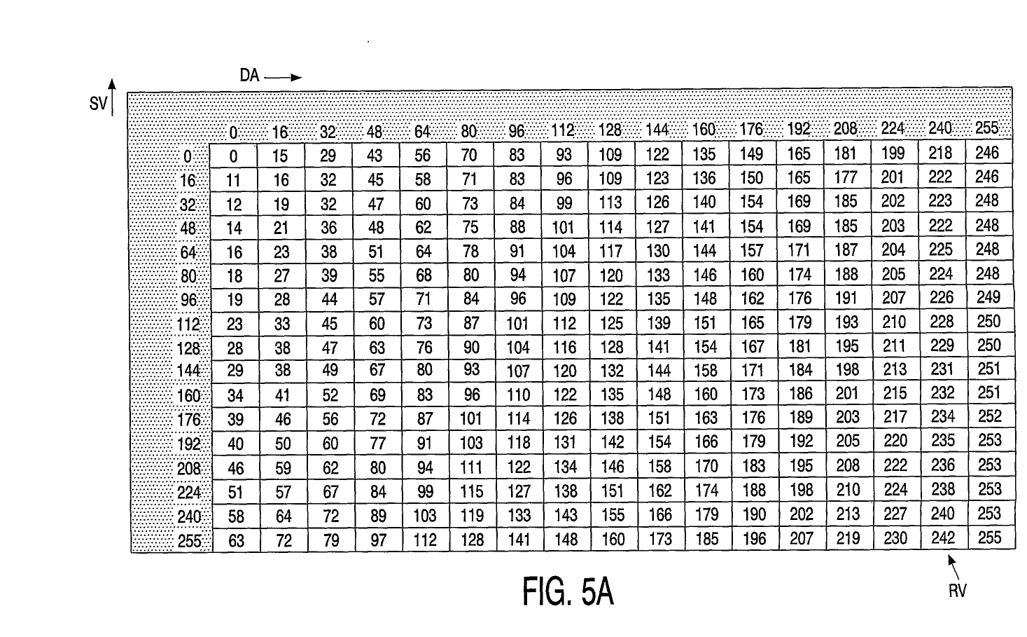

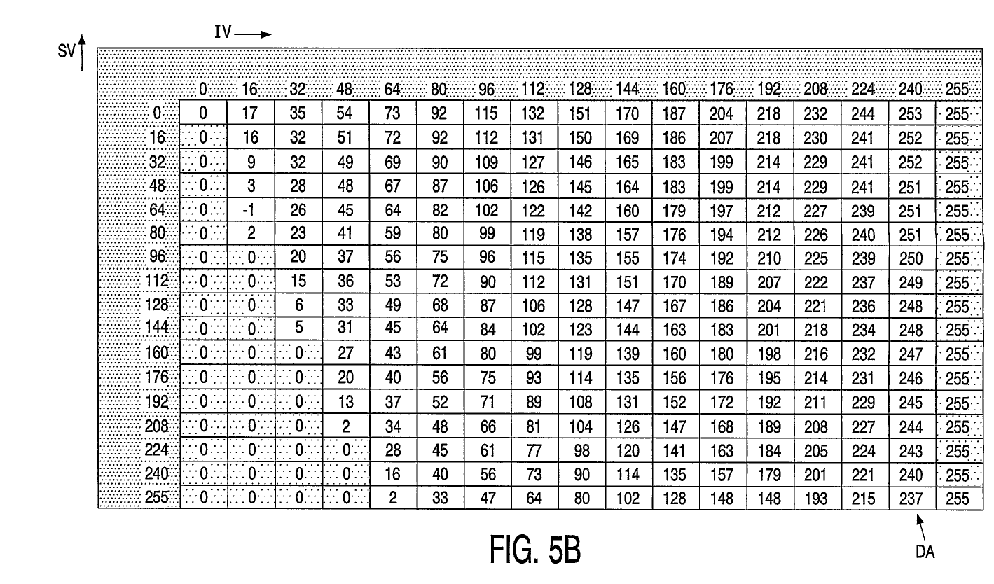

The overdrive circuit OV receives an input image signal IV at a data input DE, a start value SV at a start value input SVI, and supplies the overdriven data DA and a response value RV. The input image values IV represent the input image to be displayed. The overdriven data DA is supplied to one of the sub-pixels SPij of the display panel 1. The frame buffer FB receives the response value RV supplied by the overdrive circuit OV and supplies the response value RV delayed over one frame period Tf as the start value SV to the start value input SVI of the overdrive circuit OV. Thus, the overdrive circuit OV receives for each sub-pixel SPij both the start value or previous data SV indicating the brightness level of the sub-pixel SPij during a previous frame period Tfp, and the input image values or the present data IV indicating the brightness level the sub-pixel SPij should reach during the present frame period Tf. The overdrive circuit OV uses the tables 1 and 2 as will be elucidated with respect to FIG. 5 to determine the level of the overdriven data DA and the value of the response value RV.

FIG. 5 show look up tables used in the prior art feedback overdrive circuit.

FIG. 5A shows table 1 which provides the response values RV of a sub-pixel SPij. The starting value SV or the previous data value of the sub-pixel SPij is given in the left most column of the matrix. The actual drive data level DA is provided in the top row of the matrix. Starting from a starting value SV given in the left most column, for example the level 224, it can be found that if this sub-pixel SPij is driven with a particular level in the top row, for example the level 16, the resultant response value RV after one frame period Tf can be found in the cell corresponding with the intersection of the row starting at the left with 224 and the column starting at the top with 16, and thus is 57. Thus, in this example, instead of the brightness transition corresponding to the data transition from 224 to 16, after one frame period Tf, a brightness transition is made corresponding to the data transition from 224 to 57. The sub-pixel SPij will have a higher brightness level after one frame period Tf than the desired value 16. The brightness error made corresponds to a data difference of 41 which is a substantially high amount if is realized that the data difference of 255 is the difference between a zero brightness and the maximum brightness. Thus, if the value 16 instead of 57 is used in the next frame as the start value SV a large error will be made in calculating the required overdrive value DA.

FIG. 5B shows table 2 which provides the overdrive values DA. Again, the starting value SV of the sub-pixel SPij is given in the left most column of the matrix. The desired data level IV is provided in the top row of the matrix. For the same example as given with respect to FIG. 5A, it can be found that if the start level SV is 224 and the desired level IV is 16, a drive signal DA of 0 has to be applied. The gray shading of the value 0 indicates that in fact a lower value is required to reach the desired level 16. But due to the fact the minimum drive value MID is limited, in this example to 0, the lowest possible drive value is supplied to the sub-pixel SPij. Thus the overdrive value applied is clipped to the minimum drive value MID available, and as can be found from table 1 the resultant level after one frame period will be 51 (start value SV is 224, overdrive value is 0) instead of 16.

In the prior art, for each sub-pixel SPij the overdrive value DA can be found in the table 2 by using the start value SV and the input value IV, and the response value RV can be found in the table 1 by using the start value SV and the overdrive value DA. This approach thus requires two tables, one to be able to determine the overdrive value DA, and one to determine the response value RV to be stored in the frame memory FB such that the start value SV which is the response value RV delayed over one frame period Tf has a value representing the actual drive value of the pixel 10 during the preceding frame period Tfp.

Alternatively, it is possible to replace one or both the tables of FIGS. 5A and 5B as functions of two input parameters and representing the plane of values of the tables. Such functions are relatively complex as they depend on two variables, their powers and cross terms and a relatively large number of associated coefficients.

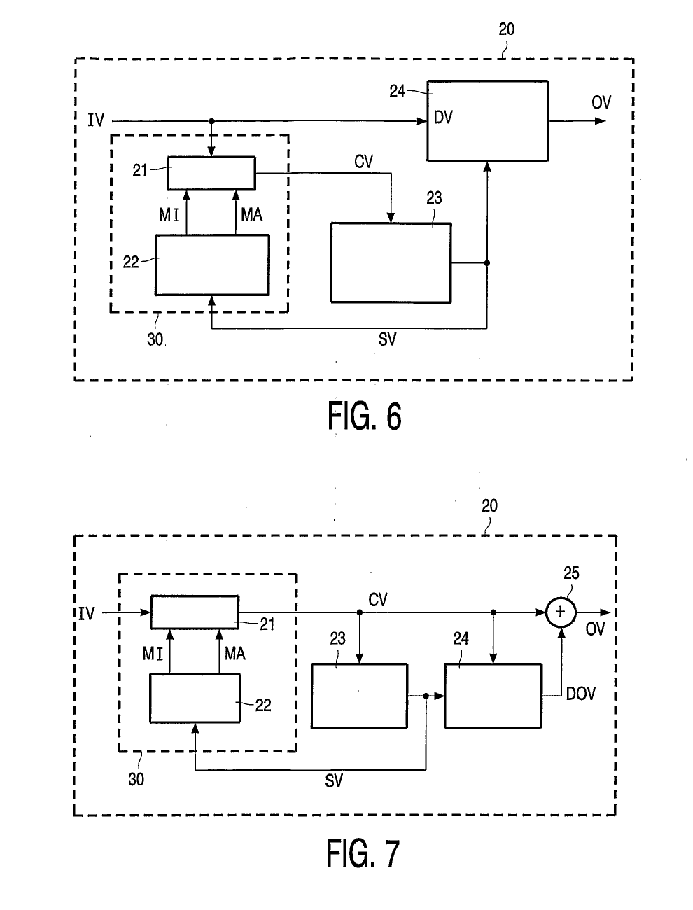

FIG. 6 shows a block diagram of an embodiment of a feedback overdrive circuit in accordance with the invention. The table look up unit 24 has an input DV to receive the input video values IV, and further receives the start values SV. The table look up unit 24 supplies the overdrive values OV to the sub-pixels SPij. The substituting circuit 30 comprises a table circuit 22 and a clipper 21. The substituting circuit 30 substitutes the input value IV with a response value called the clipped value CV which, starting from the start value SV is reachable within one frame period Tf. Instead of using the relatively large prior art matrix table which provides the response value RV for each start grey level SV and each drive level OV, now a relatively small table can be used which only comprises the minimum and maximum values MI and MA obtainable from the start values SV.

The table circuit 22 receives the start value SV from the memory 23 and supplies the minimum value MI and the maximum value MA. The table circuit 22 comprises a table (see FIG. 8) which for different start values SV comprises the associated minimum values MI and maximum values MA reachable from the associated start value SV when the minimum drive value MID or the maximum drive value MAD, respectively, is supplied to the sub-pixel SPij. The table circuit 22 provides for the received start value SV the associated minimum value MI and the associated maximum value MA to the clipper 21. Usually, the table is pre-filled with data experimentally determined by driving the sub-pixels SPij of an actual matrix display or a particular kind of matrix displays. The table may provide values only for a selected number of start values SV. For a start value SV in-between two neighboring start values SV present in the table the associated minimum and maximum values MI, MA are interpolated from the minimum and maximum values MI, MA associated with the neighboring start values SV present in the table.

The clipper 21 receives the input values IV, the minimum values MI, and the maximum values MA to supply the clipped values CV which are stored in the frame memory 23. The clipped value CV is: (i) the input value IV if the level of the input value IV is higher than the minimum value MI and lower than the maximum value MA, or (ii) the minimum value MI if the input value IV is equal to or lower than the minimum value MI, or (iii) the maximum value MA if the input value IV is equal to or higher than the maximum value MA.

It is in the now following assumed that the memory 23 provides the correct start value SV. It will become clear that the approach in accordance with the invention indeed provides the correct start value SV. If the substitute circuit 30 determines that the input value IV is in-between the minimum value MI and the maximum value MA this input value IV gives rise to an overdrive signal OV which is in-between the minimum drive value MID and the maximum drive value MAD. This is true because the minimum value MI and the maximum value MA are the values reachable by the overdrive circuit 24 by supplying the minimum drive value MID or the maximum drive value MAD, respectively. Consequently, the desired input value IV will be reached within one frame period Tf and thus the clipped value CV to be stored in the memory 23 for this sub-pixel SPij as the start value SV for the next frame Tfn is equal to the input value IV.

If the substitute circuit 30 determines that the input value IV is equal to or below the minimum value MI it is clear that this input value IV cannot be reached in one frame period Tf with the overdrive circuit 24. The overdrive value OV supplied will be the lowest value possible to reach the desired input value IV as close as possible within the single frame period Tf. The lowest value possible is the minimum drive value MID. This minimum drive value MID will cause the sub-pixel SPij to change within the frame period Tf to an optical state corresponding to the minimum value MI. Thus, now the input value IV is clipped to the minimum value MI and the minimum value MI is stored in the memory 23. Consequently, the corresponding start value for the next frame is the minimum value MI which indeed corresponds to the optical state the sub-pixel Spij has reached during the previous frame.

If the substitute circuit 30 determines that the input value IV is equal to or above the maximum value MA it is clear that this input value IV cannot be reached in one frame period Tf with the overdrive circuit 24. The overdrive value OV supplied will be the highest value possible to reach the desired input value IV as close as possible within the single frame period Tf. The highest value possible is the maximum drive value MAD. This maximum drive value MAD will cause the sub-pixel SPij to change within the frame period Tf to an optical state corresponding to the maximum value MA. Thus, now the input value IV is clipped to the maximum value MA and the maximum value MA is stored in the memory 23. Consequently, the corresponding start value for the next frame is the maximum value MA which indeed corresponds to the optical state the sub-pixel Spij has reached during the previous frame.

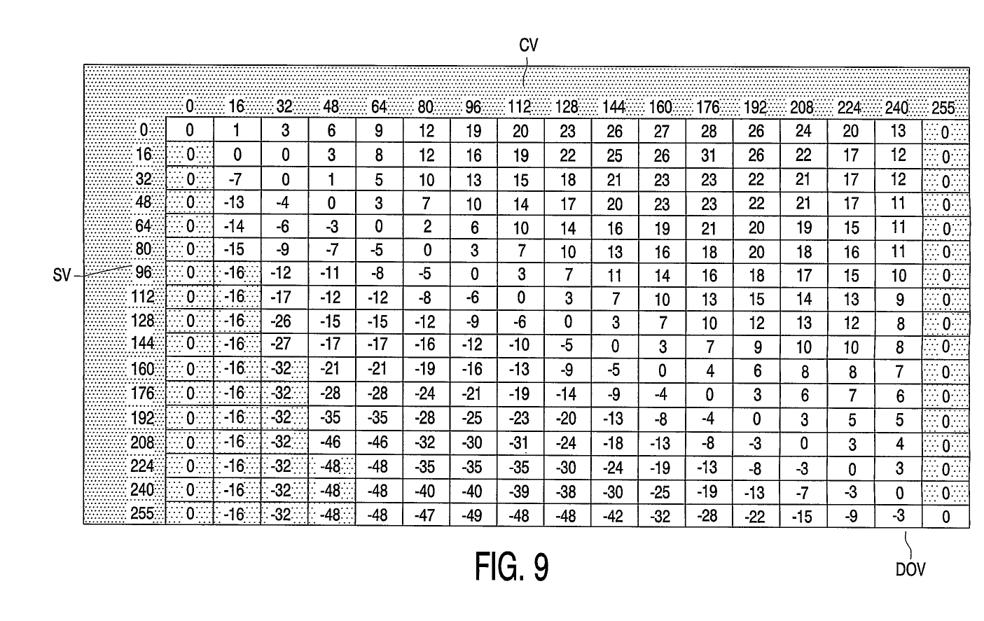

FIG. 7 shows a block diagram of another embodiment of a feedback overdrive circuit. The same items as discussed with respect to FIG. 6 have the same function and need not be elucidated again. In the now following, the optional adder 25 is not present. Then, the only difference with respect to FIG. 6 is that the clipped value CV instead of the input value IV is supplied to the input DV of the overdrive circuit 24. Now, particular addresses of the prior art matrix table used by the overdrive circuit 24 are not used anymore. This can be used to save memory. The shaded area of the matrix table in FIG. 9 is an example indicating which part of the matrix is not used anymore.

The optional adder 25 is introduced if the prior art matrix table comprises difference overdrive values DOV which indicate the difference between the desired value DV and the overdrive value OV. The adder 25 sums these difference overdrive values DOV and the corresponding desired values DV to obtain the output values OU supplied to the sub-pixels SPij. The advantage of using the difference values DOV is that these values requires less bits to be represented and thus lower the amount of memory required for the matrix table of the overdrive circuit 24. This matrix table comprising difference overdrive values DOV, and the adder 25 may also be added to the feedback overdrive circuit of FIG. 6.

FIG. 8 shows an embodiment of the table comprising the minimum and maximum values. The table of FIG. 8 only has three columns, the left most column shows the start values SV. The middle column shows the minimum values MI which are obtained when the minimum drive value MID is supplied to the sub-pixel SPij which has an optical state corresponding to the start value SV. The right most column shows the maximum values MA which are obtained when the maximum drive value MAD is supplied to the sub-pixel SPij which has an optical state corresponding to the start value SV. For example, if the sub-pixel SPij at the start of the frame period Tf is in an optical state corresponding to the start value 224, and the drive level 0 (minimum brightness) is supplied, at the end of the frame period Tf, the optical state of the sub-pixel Spij corresponds to the drive value 51.

Alternatively, it is possible to determine the minimum values MI and the maximum values MA as a function of the start value SV. For example, for the table shown in FIG. 8, the next two functions may be used:

MI=0.0004SV²+0.1097SV+5,9002

MA=0.0327SV+246.06.

It has to be noted that the coefficients of the function may be selected to be less accurate. For another display, other coefficients and other functions may be required.

Thus, in one frame period Tf the brightness of the sub-pixel starting from the relatively high brightness corresponding to the drive value 224 cannot drop lower than to the lower brightness corresponding to the drive value 51. If the sub-pixel SPij at the start of the frame period Tf is in an optical state corresponding to the start value 224, and the drive level 255 (maximum brightness) is supplied, at the end of the frame period Tf, the optical state of the sub-pixel SPij can not change to a higher brightness than the brightness corresponding to the drive value 253.

The table shown is an example only, the table may comprise more or less than 17 rows. The minimum values MI and the maximum values MA for a start value SV which is not present in the table can be determined by interpolation. The interpolation may be linear, cubic, or of an higher order. It is also possible to use spline functions which optimally fit the values in the table.

FIG. 9 shows an example in accordance with the invention indicating the area of the matrix table which is not anymore used. FIG. 9 shows a preferred embodiment of the matrix table used in the overdrive circuit 24. The left most column shows the start value SV.

The top row shows the desired level at the input DV of the overdrive circuit 24. This desired level is the clipped value CV as shown in FIG. 7. The values in the cells of the matrix represent the differential overdrive values DOV. Now fewer bits are required to store the values. To elucidate the use of this table, an example: if the start value is 80 and the desired level is 16, the differential drive value is −15. Thus, the value 16−15=1 has to be supplied to the sub-pixel SPij as the drive value.

The light gray areas in the table are values which will not occur because the clipped values CV instead of the input values IV are supplied to the input DV of the overdrive circuit 24. Thus the sum of a particular clipped value CV and the associated differential overdrive value DOV cannot be below the minimum drive value 0 nor above the maximum drive value 255. Thus, for example, if the start value is 224 and the desired value 16, it is impossible to reach the desired value within one frame period Tf. This is clear from FIG. 8, the minimum value which can be reached in one frame period Tf starting from the start value 224 is 51. Thus the cell in the matrix corresponding to the start value SV of 224 and the desired value 16 will never be addressed because the clipped signal will have the value 51.

It should be noted that the above-mentioned embodiments illustrate rather than limit the invention, and that those skilled in the art will be able to design many alternative embodiments without departing from the scope of the appended claims. For example the pixel 10 mentioned in the claims may be a pixel of the display panel 1 if this display device is a monochrome display. Alternatively, the pixel 10 mentioned in the claims may be one of the sub-pixels SPij of a multicolor display.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. The overdrive circuit 20 may be formed by one or more integrated circuits or by one or more electronic modules comprising the one or more integrated circuits and optionally additional components. In the device claim enumerating several means, several of these means may be embodied by one and the same item of hardware. The mere fact that certain measures are recited in mutually different dependent claims does not indicate that a combination of these measures cannot be used to advantage.

To conclude, in a preferred embodiment, the overdrive circuit 20 for the display panel 1 comprising a pixel 10 having inertia comprises a table look up circuit 24 or a function circuit 24 which receives a start value SV and a desired value DV being either an input value IV indicating an image to be displayed, or a clipped value CV and which supplies an overdrive value OV to the pixel 10. A substituting circuit 30 substitutes the input value IV by a reachable response within one frame period Tf starting from the start value SV to obtain the clipped value CV. A frame memory 23 receives the clipped value CV to supply the start value SV which is the clipped value CV delayed over the one frame period Tf. The substituting circuit 30 comprises a table look up circuit or a function circuit 22 which indicates for the start value SV a corresponding minimum value MI reached from the start value SV within one frame period Tf if a minimum drive value MID is applied to the pixel 10, and a corresponding maximum value MA reached from the start value SV within one frame period Tf if a maximum drive value MAD is applied to the pixel 10.

1. An overdrive circuit (20) for a display panel (1) comprising a pixel (10) having inertness, the circuit (20) comprising:
a means (24) for receiving a start value (SV) and a desired value (DV) being either an input value (IV) indicating an image to be displayed, or a clipped value (CV) to supply an overdrive value (OV) to the pixel (10),
means (30) for substituting the input value (IV) by a reachable response within one predetermined period (Tf) starting from the start value (SV) to obtain the clipped value (CV), and
a memory (23) for receiving the clipped value (CV) to supply the start value (SV) being the clipped value (CV) delayed over the one predetermined period (Tf), wherein
the means (30) for substituting comprises a means (22) for indicating for the start value (SV) a corresponding minimum value (MI) being reachable from the start value (SV) within one predetermined period (Tf) when a minimum drive value (MID) is applied to the pixel (10), and a corresponding maximum value (MA) being reachable from the start value (SV) within one predetermined period (Tf) when a maximum drive value (MAD) is applied to the pixel (10).

2. An overdrive circuit as claimed in claim 1, wherein the predetermined period (Tf) is a frame period (Tf).

3. An overdrive circuit as claimed in claim 1, wherein the means (24) for receiving comprises a table look up circuit (24) for providing an overdrive value (OV) for pairs of the start value (SV) and the desired value (DV).

4. An overdrive circuit as claimed in claim 1, wherein the means (22) for indicating comprises a table look up circuit for providing the minimum value (MI) and the maximum value (MA) for the start value (SV).

5. An overdrive circuit as claimed in claim 1, wherein the means (22) for indicating comprises a function circuit (22) for generating the minimum value (MI) and the maximum value (MA) from the start value (SV) in accordance with at least one predetermined function.

6. An overdrive circuit as claimed in claim 4, wherein the table (22) comprises for all possible start values (SV) a corresponding minimum value (MI) and a corresponding maximum value (MA).

7. An overdrive circuit as claimed in claim 4, wherein the table (22) comprises for a subset of all possible start values (SV) a corresponding stored minimum value (SMI) and a corresponding stored maximum value (SMA), and wherein the means (30) for substituting are arranged for interpolating the minimum value (MI) and the maximum value (MA) for a start value (SV) in-between start values (SV) stored in the table (22) from corresponding stored minimum values (SMI) and stored maximum values (SMA) available in the table (22).

8. An overdrive circuit as claimed in claim 1, wherein the means (30) for substituting comprises a clipping means (21) for receiving the input value (IV) representing a brightness of the pixel (10) in a present predetermined period (Tf), the minimum value (MI), and the maximum value (MA) to supply the clipped value (CV) being: (i) the input value (IV) if a level of the input value (IV) is higher than the minimum value (MI) and lower than the maximum value (MA), or (ii) the minimum value (MI) if the input value (IV) is equal to or lower than the minimum value (MI), or (iii) the maximum value (MA) if the input value (IV) is equal to or higher than the maximum value (MA).

9. An overdrive circuit as claimed in claim 3, wherein the table look up circuit (24) comprises difference overdrive values (DOV) representing a difference between the desired value (DV) and the overdrive value (OV), and in that the feedback overdrive circuit (20) further comprises an adder (25) for summing the difference overdrive values (DOV) and the corresponding desired values (DV).

10. A display device comprising the overdrive circuit (20) as claimed in claim 1, and the display panel (1).

11. A display apparatus comprising the display device as claimed in claim 10, and signal processing circuitry (SPC).

12. A method of overdriving a pixel of a display panel, the pixel having inertia, the method comprising:
receiving (24) a start value (SV) and a desired value (DV) being either an input value (IV) indicating an image to be displayed, or a clipped value (CV) for supplying (24) an overdrive value (OV) to the pixel (10),
substituting (30) the input value (IV) by a reachable response within one predetermined period (Tf) starting from the start value (SV) to obtain the clipped value (CV), and
storing (23) the clipped value (CV) to supply the start value (SV) being the clipped value (CV) delayed over the one predetermined period (Tf), wherein
the substituting (30) uses a step (22) of indicating for the start value (SV) a corresponding minimum value (MI) being reachable from the start value (SV) within one predetermined period (Tf) when a minimum drive value (MID) is applied to the pixel (10), and a corresponding maximum value (MA) being reachable from the start value (SV) within one predetermined period (Tf) when a maximum drive value (MAD) is applied to the pixel (10).
